(19) United States
(12) Patent Application Publication
(10) Pub. No.: US 2012/0185417 A1
(43) Pub. Date: Jul. 19, 2012

(54) APPARATUS AND METHOD FOR GENERATING ACTIVITY HISTORY

(75) Inventor: Masayuki Okamoto, Kanagawa-ken (JP)

(73) Assignee: KABUSHIKI KAISHA TOSHIBA, Tokyo (JP)

(21) Appl. No.: 13/237,004

(22) Filed: Sep. 20, 2011

(30) Foreign Application Priority Data
Jan. 17, 2011 (JP) P2011-006974

(51) Int. Cl. G06F 15/18; G06F 7/00

(52) U.S. Cl. 706/12; 707/812; 707/E17.044

(57) ABSTRACT

According to one embodiment, a context acquisition unit acquires a context of a user and a date when the context has occurred. A context storage unit stores the context and the date. An activity information storage unit stores activity information of the user and date information to schedule the activity information. A first assignment unit assigns, to a first date corresponding to the date information, the activity information or an activity label extracted from the activity information. A second assignment unit assigns, to a second date to which the activity information or the activity label is not assigned, an activity label by using the context of the second date and an activity label assignment rule previously trained.

### CROSS-REFERENCE TO RELATED APPLICATION

This application is based upon and claims the benefit of priority from Japanese Patent Application No. 2011-006974, filed on Jan. 17, 2011; the entire contents of which are incorporated herein by reference.

### FIELD

Embodiments described herein relate generally to an apparatus and a method for generating an activity history.

### BACKGROUND

As a conventional technique of a cellular phone, a recorded information of date and place, and an input schedule into a schedule table, are correspondingly displayed. Furthermore, a technique to detect an abnormal activity unmatched with a predefined activity pattern by observing a user's activity pattern and a technique to create an activity model by training the user's activity pattern are proposed.

However, in these techniques, a history of an activity which the user has not input into the schedule table cannot be retrieved.

### BRIEF DESCRIPTION OF THE DRAWINGS

FIG. 1 is a block diagram of an activity history generation apparatus according to one embodiment.

FIG. 2 is a flowchart of a training processing of an activity label assignment rule according to the one embodiment.

FIG. 3 is a schematic diagram of a correspondence relationship between an activity label and a primitive context according to the one embodiment.

FIG. 4 is a schematic diagram of the activity label assignment rule (decision tree).

FIG. 5 is a schematic diagram of the activity label assignment rule (rule table).

FIG. 6 is a flow chart of an assignment processing of the activity label.

FIG. 7 is a schematic diagram of an assignment context of the activity label.

FIG. 8 is a schematic diagram of an activity history according to the one embodiment.

FIG. 9 is a schematic diagram of an application to retrieve the activity history.

### DETAILED DESCRIPTION

According to one embodiment, an apparatus for generating an activity history includes a context acquisition unit, a context storage unit, an activity information storage unit, a first assignment unit, and a second assignment unit. The context acquisition unit is configured to acquire a context of a user and a date when the context has occurred. The context storage unit is configured to store the context and the date. The activity information storage unit is configured to store activity information of the user and date information to schedule the activity information. The first assignment unit is configured to assign, to a first date corresponding to the date information, the activity information or an activity label extracted from the activity information. The second assignment unit is configured to assign, to a second date to which the activity information or the activity label is not assigned, an activity label by using the context of the second date and an activity label assignment rule previously trained.

Various embodiments will be described hereinafter with reference to the accompanying drawings.

As to an activity history generation apparatus according to the present embodiment, it is imagined to be installed onto a portable hardware device (For example, a smart phone or a net book) having various sensors such as an acceleration sensor, a GPS sensor or a proximity sensor, in order to retrieve a user's activity history. In this case, as to the user's activity at the date of which schedule was previously registered by the user, an activity history is retrieved by using a retrieval tag (activity label) extracted from the schedule. On the other hand, as to the user's activity at the date of which schedule was not registered by the user, the activity history is retrieved by using an activity label automatically assigned by the activity history generation apparatus. In order to assign the activity label, a rule (activity label assignment rule) previously trained to assign the activity label, and an index (primitive context) representing a user's context (acquired from sensor information by the activity history generation apparatus), are used. In this case, the context means a situation. The activity label assignment rule is trained by using the activity label extracted from activity information (schedule) registered to the apparatus and the index representing the user's context occurred at the data corresponding to the activity information.

(Whole Component)

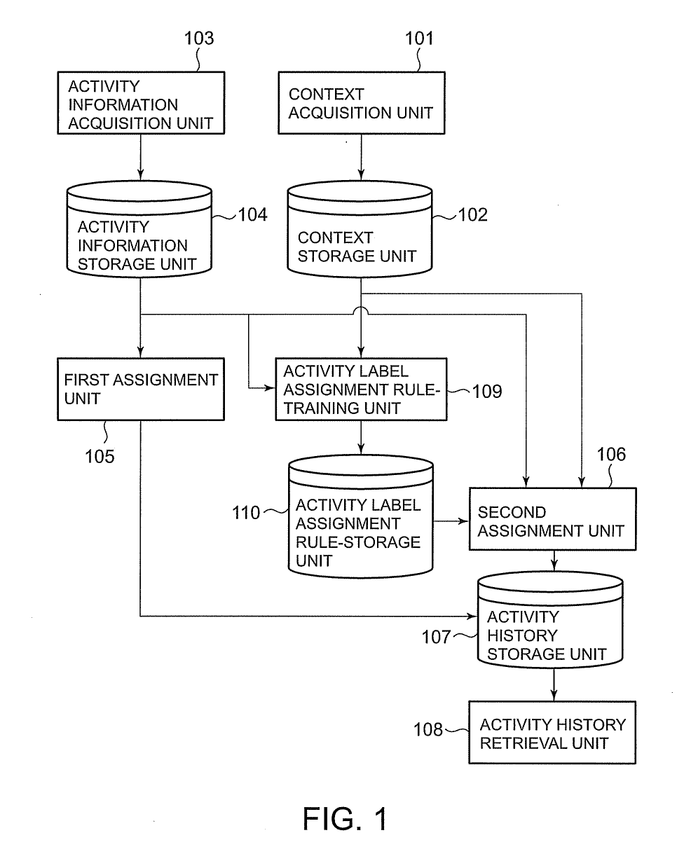

FIG. 1 is a block diagram of the activity history generation apparatus (Hereinafter, it is called “an apparatus”) according to the present invention. The apparatus includes a context acquisition unit 101, a context storage unit 102, an activity information acquisition unit 103, an activity information storage unit 104, a first assignment unit 105, a second assignment unit 106, an activity history storage unit 107, an activity history retrieval unit 108, an activity label assignment rule-training unit 109, and an activity label assignment rule-storage unit 110.

The context acquisition unit 101 acquires a user's primitive context and an occurrence date thereof. The primitive context is an index representing the user's context, which is acquired by sensor information from various sensors (an acceleration sensor, a GPS sensor, a proximity sensor) loaded onto the apparatus, video acoustic information from a camera or a microphone, and operation history information of the apparatus. For example, from sensor information of the acceleration sensor, information representing whether the user's context is “stillness” or “walking” is acquired. Furthermore, from sensor information of the proximity sensor, the number of terminals adjacent to the apparatus is acquired. Furthermore, from acoustic information of the microphone, existence (or non-existence) of speech and a pitch (loudness) thereof are acquired. Except for this, the user's primitive context may be acquired by using labeling technique disclosed in JP-A 2010-74278 (Kokai). Moreover, the occurrence date represents a date when the user's primitive context has occurred.

The context storage unit 102 stores the user's primitive context and the occurrence data thereof (acquired by the context acquisition unit 101).

The activity information acquisition unit 103 acquires the user's schedule (registered into the apparatus) as activity information. The activity information represents the user's schedule (For example, “Meeting for development @The first council room (10:00-12:00)”) registered into the apparatus. In the present embodiment, the activity information includes information (date information) related to date of schedule, for example, “a start time is 10:00 and a completion time is 12:00”. Furthermore, as the activity information, not only the schedule (registered into the apparatus by the user) but also some text corresponding to the date information may be utilized. Moreover, the activity information is a concept encompassing an activity label (explained afterwards).

The activity information storage unit 104 stores the activity information acquired by the activity information acquisition unit 103.

The first assignment unit 105 assigns a retrieval tag (extracted from activity information (schedule) previously registered by the user) to a date corresponding to the schedule. Concretely, as to the date corresponding to activity information registered into the activity information storage unit 104, the activity information or an activity label extracted the activity information is assigned. As the activity label, the user's activity is classified into each category such as “meeting”, “moving” and “diner party”, which is extracted from the activity information (schedule) by using a morphological analysis rule or a built-in rule. For example, when activity information corresponding to “10:00-12:00 of Dec. 26, 2010” is stored in the activity information storage unit 104, the first assignment unit 105 assigns the activity information or an activity label extracted from the activity information to this date.

The second assignment unit 106 assigns a retrieval tag (activity label) to a date of which activity information (schedule) is not registered by the user. Concretely, as to the data to which the first assignment unit 105 has not assigned activity information or an activity label, the second assignment unit 106 assigns the activity label by using an activity label assignment rule and a primitive context occurred at this date. For example, when activity information corresponding to “13:00-14:00 of Dec. 26, 2010” is not stored in the activity information storage unit 104, the second assignment unit 106 assigns an activity label to this date. Detail processing of the second assignment unit 106 is explained afterwards.

The activity history storage unit 107 stores the activity information (or the activity label) assigned by the first assignment unit 105 and the activity label assigned by the second assignment unit 106 with date information thereof, as an activity history.

The activity history retrieval unit 108 executes retrieval of the activity history stored in the activity history storage unit 107.

The activity label assignment rule-training unit 109 trains an activity label assignment rule by using the activity label (extracted from activity information) as a classified class and the primitive context (occurred at the date corresponding to the activity information) as an attribute. In above-mentioned example, by using the activity label extracted from activity information corresponding to “10:00-12:00 of Dec. 26, 2010” (as the classified class) and the primitive context occurred at this date (as the attribute), the activity label assignment rule is trained. Detail processing of training is explained afterwards.

The activity label assignment rule-storage unit 110 stores the activity label assignment rule trained by the activity label assignment rule-training unit 109.

(Flow Chart: Training of Activity Label Assignment Rule)

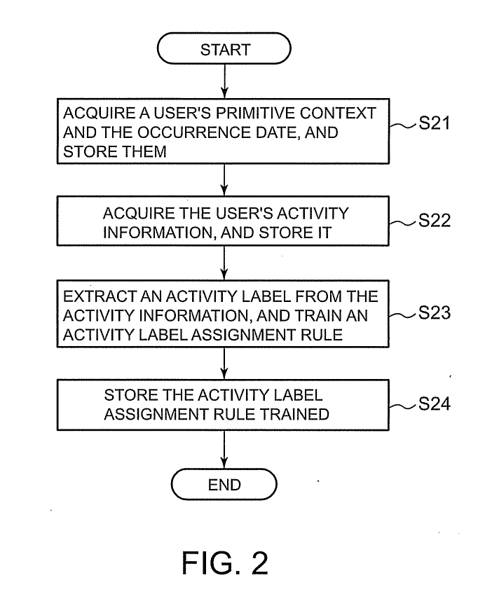

FIG. 2 is a flow chart of training of the activity label assignment rule by the apparatus. First, the context acquisition unit 101 acquires a user's primitive context and an occurrence data thereof from sensor information and the user's operation history (of the apparatus), and stores them into the context storage unit 102 (S21). In the present embodiment, as the user's primitive context, “moving context”, “proximity context”, “utterance context” and “operation context”, are acquired. The moving context represents the user's primitive context acquired from sensor information by the acceleration sensor or GPS sensor, for example, classification of moving such as “stillness”, “walking”, “electric car” and “automobile”. The proximity context represents the user's primitive context acquired from the proximity sensor or wireless device connection device (such as WiFi, Bluetooth), for example, classification of the number of other users (such as “one”, “two”) adjacent to the user, or a specific terminal ID detected. The utterance context represents the primitive context of sound characteristic in acoustic information inputted from the microphone, for example, existence (or non-existence) of person's utterance, a volume, or a pitch (loudness). The operation context represents the primitive context of the user's operation of the apparatus, for example, “input of character”, “preservation of file”, “inspection of file” and “inspection of Web”. The context acquisition unit 101 acquires the occurrence date of these primitive contexts. Concrete example of the primitive context is explained afterwards.

Next, the activity information acquisition unit 103 acquires the user's schedule as activity information, and stores it into the activity information storage unit 104 (S22). The activity information registered as the schedule includes date information such as a start date and a completion date.

The activity label assignment rule-training unit 109 trains the activity label assignment rule. Concretely, the activity label assignment rule-training unit 109 extracts an activity label from activity label (stored in the activity information storage unit 104), and trains the activity label assignment rule by using the activity label (as a classified class) and the primitive context occurred at a date corresponding to the activity information (as an attribute) (S23).

First, extraction of the activity label by the activity label assignment rule-training unit 109 is explained. If the activity information includes (who, what, where, which, how) information, i.e., if one text includes a content, a place and a date such as “Meeting for development @the first council room (10:00-12:00)”, the text is divided into a plurality of parts by using a morphological analysis or a built-in rule, and “meeting for development” is acquired as the activity label. In this case, place information (“the first council room”) and data information (“start time is 10:00”, “completion time is 12:00”) are used as the attribute for training. Moreover, if the activity information is the activity label itself such as “meeting”, the activity information is used as the activity label.

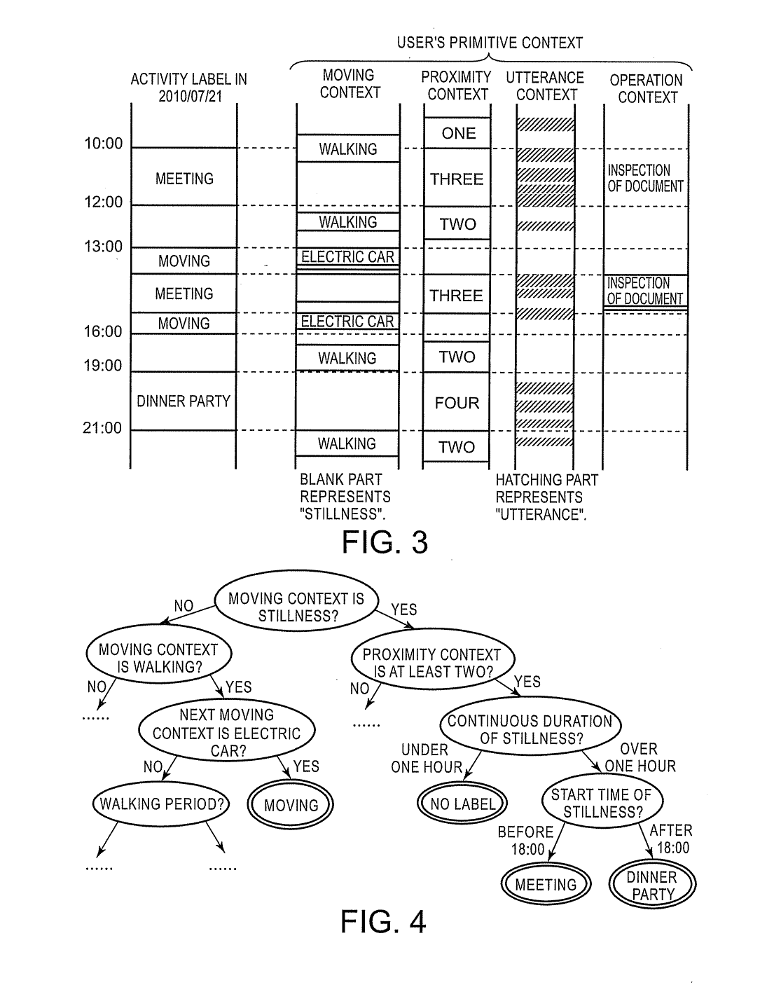

Next, training of the activity label assignment rule by the activity label assignment rule-training unit 109 is explained. The case of using a decision tree as the activity label assignment rule is explained as a concrete example. FIG. 3 shows a correspondence relationship between an activity label (extracted from activity information) and a primitive context occurred at a date corresponding to the activity label. In FIG. 3, “activity label in Jul. 21, 2010” represents the activity label extracted from activity information registered (by the user) as a schedule of Jul. 21, 2010. For example, at 10:00-12:00 of this day, “meeting” was already registered as the schedule. In FIG. 3, as the user's primitive context, “moving context”, “proximity context”, “utterance context” and “operation context” are acquired. As to the moving context, a blank part where “walking” or “electric train” is not recorded represents “stillness”. The proximity context represents the number of other users adjacent to the user. As to the utterance context, a period having utterance is displayed as a hatching part. Except for this, as the primitive context representing the utterance context, a ratio of a period having utterance to the data corresponding to each activity label may be used.

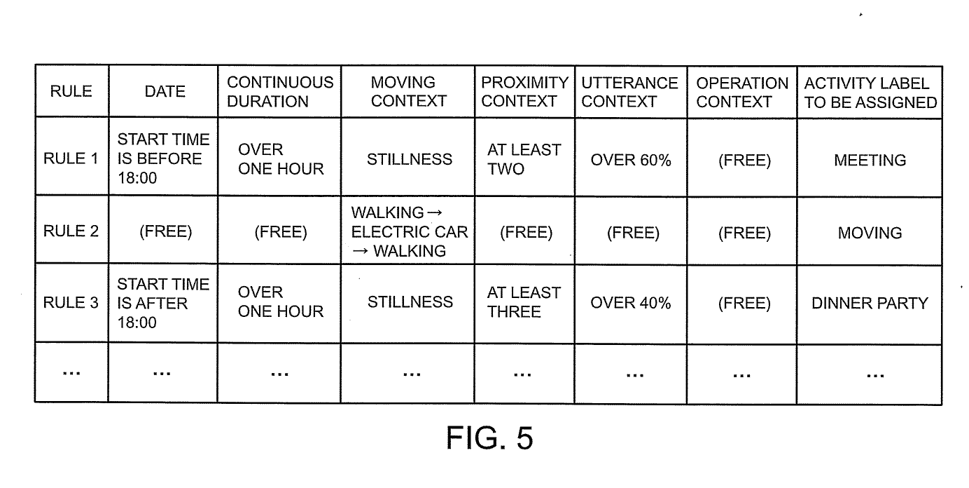

In order to train a decision tree, C4.5 algorithm is used. As to this algorithm, training data having classified classes and attributes is prepared, and the decision tree is composed so as to maximize a gain of information quantity thereof. As the classified class, the activity label extracted from activity information (stored in the activity information storage unit 104) is used. As the attribute, the user's primitive context occurred at date corresponding to the activity label, and information of date and place extracted from the activity information, are used. In an example of 10:00-12:00 of FIG. 3, the activity label “meeting” is used as the classified class. The moving context (“stillness”) at date corresponding to this activity label, a transition (“walking”→“stillness”→“walking”) of the moving context, the proximity context (“three”) and the operation context (“inspection of document”) are used as the primitive context. In addition to the primitive context, by using date information (a start time “10:00”, a continuous duration “two hours” of activity label) as the attribute, the decision tree is trained. FIG. 4 shows an example of the decision tree obtained by training. Furthermore, as shown in FIG. 5, a rule table having a matching pattern as a process to trace branches of the decision tree may be used as the activity label assignment rule.

As the attribute used for training the decision tree, not only the primitive context occurred at a date corresponding to each activity label but also a primitive context at a period having a predetermined time (for example, fifteen minutes) before and after the date may be used. Furthermore, in the present embodiment, the decision tree is trained as the activity label assignment rule (a classifier). However, if only the decision tree is trained by using the classified class and the attribute thereof, training method is not limited to the classifier. For example, by using SVM (Support Vector Machine) as the classifier, the decision tree may be trained as the activity label assignment rule. Furthermore, when the decision tree is trained by using classified classes having few training data quantity, over-fitting occurs. Accordingly, classified classes of which training data quantity is larger than a predetermined threshold may be used for training.

Last, the activity label assignment rule-storage unit 110 stores the activity label assignment rule such as the decision tree or the rule table trained by the activity label assignment rule-training unit 109 (524).

(Flow Chart: Assignment of Activity label)

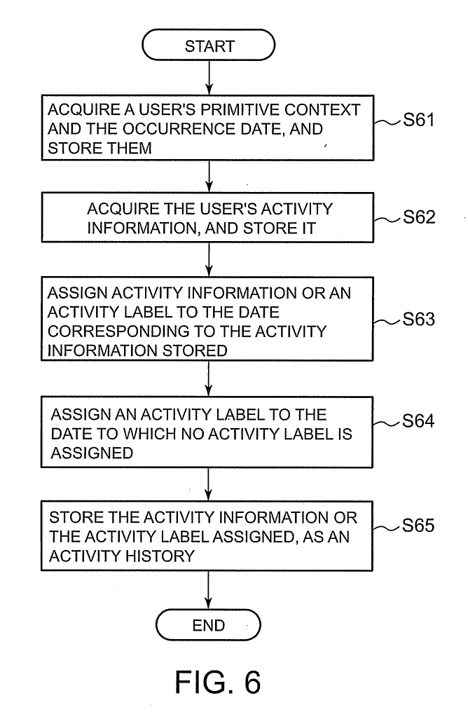

FIG. 6 is a flow chart of assigning of the activity label by the apparatus. First, in the same way as S21, the context acquisition unit 101 acquires the user's primitive context and an occurrence date thereof, and stores them into the context storage unit 102 (S61).

Next, in the same way as S22, the activity information acquisition unit 103 acquires the user's schedule as activity information, and stores in into the activity information storage unit 104 (S62).

As to a date corresponding to the activity information (stored in the activity information storage unit 104), the first assignment unit 105 assigns the activity information or an activity label extracted from the activity information (S63). The date corresponding to the activity information is decided from date information included in the activity information. For example, when activity information “meeting for development at 17:00-18:00 of Dec. 27, 2010” is registered in the apparatus, the activity label “meeting for development” is assigned to the date “17:00-18:00 of Dec. 27, 2010”. Furthermore, the activity information itself “meeting for development at 17:00-18:00 of Dec. 27, 2010” may be assigned to the same date.

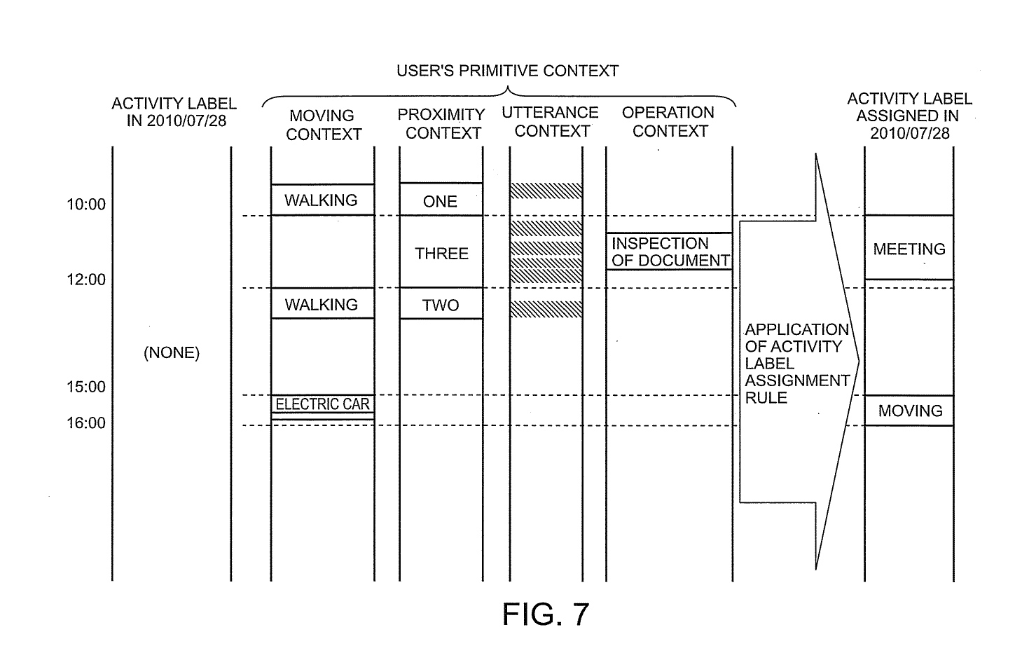

As to a date to which the first assignment unit 105 has not assigned activity information (or activity label), the second assignment unit 106 assigns an activity label by using the activity label assignment rule (previously trained) and the primitive context occurred at the date (stored in the context storage unit 102) (S64). FIG. 7 shows processing to assign the activity label to a date to which the first assignment unit 105 has not assigned activity information (or the activity label). In the present embodiment, the second assignment unit 106 utilizes the decision tree (shown in FIG. 4) or the rule table (shown in FIG. 5) as the activity label assignment rule.

In case of using the decision tree of FIG. 4, by using the primitive context occurred at a period to which activity label is not assigned and information of the period, the second assignment unit 106 replies a question (“Is the moving context stillness?”) of a head node of the decision tree. Next, by tracing a branch corresponding to this reply, the second assignment unit 106 replies a question of a next node connected with the branch. Then, until reaching a leaf node, the second assignment unit 106 traces a next branch whenever replying a question of a next node in order. Last, when the second assignment unit 106 reaches at the leaf node, the second assignment unit 106 assigns an activity label of the leaf node to this date. For example, in FIG. 7, as to the user's primitive context at a period “10:00-12:00” to which activity label is not assigned, the moving context is “stillness” and the proximity context is “three”. Furthermore, from the occurrence date of the moving context, it is acquired that “stillness continues over one hour” and “stillness starts before 18:00”. After the second assignment unit 106 replies a last question of the decision tree of FIG. 4, “meeting” is assigned to this period as the activity label.

In case of using the rule table of FIG. 5, when the primitive context and the occurrence date satisfies all conditions of each rule, the activity label is assigned. For example, as to a rule 1 of FIG. 5, when the primitive context and the occurrence date satisfy conditions “start time is before 18:00”, “continuous duration is over one hour”, “moving context is stillness”, “proximity context is at least two” and “utterance context is over 60%”, the activity label “meeting” is assigned. Furthermore, in FIG. 5, when the primitive context and the occurrence data satisfy a part of all conditions, the activity label may be assigned. If a plurality of rules is satisfied once, a plurality of activity labels is often assigned. In this case, by setting a priority to each rule based on training data quantity of each classified class (used for training), the activity label of a rule having a high priority may be assigned preferentially.

Moreover, the date to assign the activity label may be divided by a specific period. For example, as to a period of one hour such as 10:00-11:00 and 11:00-12:00, it is decided whether the first assignment unit 105 has assigned an activity label. Then, as to the period to which the activity label was not assigned, the second assignment unit 106 may assign the activity label. Furthermore, as to a date to which the first assignment unit 105 has not assigned and in which the same primitive context continues over a predetermined time, the second assignment unit 106 may assign the activity label. For example, if the date is not assigned by the first assignment unit 105 and has the same moving context over thirty minutes continuously, the activity label may be assigned.

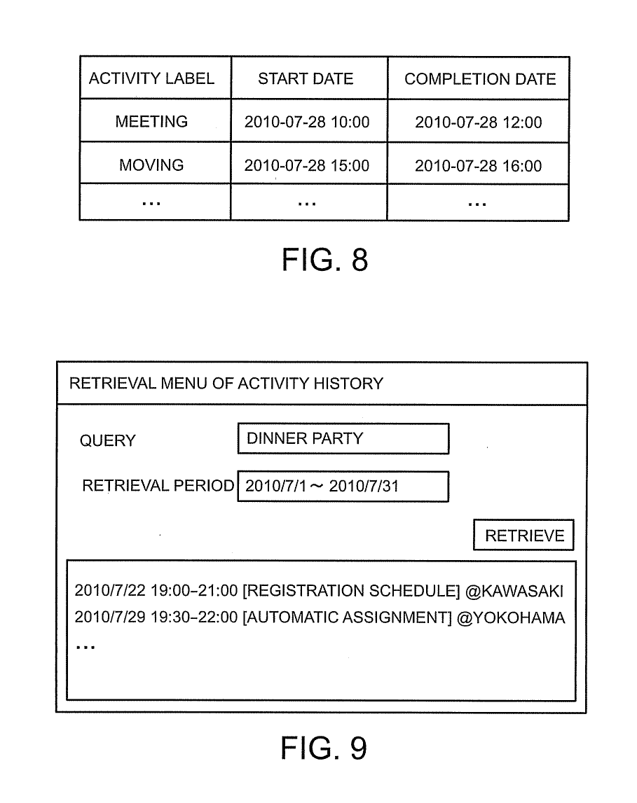

Last, the activity history storage unit 107 stores activity information (or activity label) assigned by the first assignment unit 105 and the activity label assigned by the second assignment unit 106 with date information thereof, as an activity history (S65). FIG. 8 shows an example of the activity history stored in the activity history storage unit 107. As the activity history of FIG. 8, the activity label, a start date and a completion date thereof, are correspondingly stored.

FIG. 9 shows an example of an application to retrieve the activity history by the activity history retrieval unit 108. After indicating an activity label “dinner party” (retrieval target) and a period of the retrieval target as a query, a retrieve button is pushed. In response to the retrieve button, an activity history of the retrieval target in the period is retrieved from the activity history storage unit 107. In FIG. 9, as a retrieval result, in addition to “dinner party” of Jul. 22, 2010 previously registered as activity information (schedule), activity labels of Jul. 29, 2010 automatically assigned by the second assignment unit 106 are also displayed.

(Effect)

As mentioned-above, in the apparatus of the present embodiment, a retrieval tag (activity label) is assigned to the date to which a schedule (activity information) is not registered. As a result, a user can retrieve the activity history corresponding to the data to which the user has not registered the schedule.

Furthermore, in the present embodiment, activity information (or activity label extracted from the activity information) inputted by the user is used for retrieving the activity history from the activity history storage unit 107. As a result, the user can retrieve the activity history by using a query familiar with the user.

(First Modification)

In the present embodiment, activity information and primitive context of a single user are used for training the activity label assignment rule. However, activity information and primitive context of a plurality of users may be used. In this way, by using activity information and primitive context of the plurality of users, training data quantity to train the activity label assignment rule can be increased.

Furthermore, by acquiring ID (identifier) information of another user adjacent to a specific user as a primitive context, the activity label assignment rule can be trained by using the ID information as the attribute. As a result, for example, when the specific user participates in a meeting, an activity label of the meeting is “report meeting”. However, when the specific user does not participate in a meeting, the activity label of the meeting is “investigation meeting”. Briefly, the activity label assignment rule can be trained based on participation status of the specific user.

(Second Modification)

As activity information acquired by the activity information acquisition unit 103, a text described by communication means using text (such as a chat or a micro blog) can be used. For example, some user sends a message “now in a meeting” during the meeting, or after standing talking, some user inputs “I suddenly met Mr. Tanaka just now and stood talking with him” into a micro blog. These texts are used as activity information to train the activity label assignment rule.

The case that “I stood talking with Mr. Tanaka just now” is inputted into a micro blog after standing talking is thought about. The activity information acquisition unit 103 acquires a text (inputted into the micro blog by the user) and a sending date thereof as activity information, and stores them into the activity information storage unit 104. Then, the activity label assignment rule-training unit 109 analyzes the activity information (stored in the activity information storage unit 104), and extracts an activity label and date information. As to the date information, such as “just now→five minutes before” and “this morning→9:00-12:00 in the morning of the same day”, an expression in the text is converted to date information same as the schedule.

As to the activity label, vocabulary representing activity such as “stand talking”, “meeting” and “concert” is extracted. If the text “I stood talking with Mr. Tanaka just now” was sent at 12:30 of Dec. 14, 2010, same processing as the case that a schedule “stand talking” was previously registered at 12:25 of Dec. 14, 2010 can be performed. Moreover, The date information (12:25 of Dec. 14, 2010) extracted is used as the attribute to train the activity label assignment rule.

(Third Modification)

The activity label assignment rule-training unit 109 can train the activity label assignment rule by setting activity labels decided as synonym to the same classified class. For example, when “meeting” and “mtg” are decided as synonym, the activity label assignment rule is trained by setting “meeting” to unified classified class. In this case, in order to decide whether activity labels are synonym, two methods, i.e., a method using notation and a method using primitive contexts of a plurality of users are used.

The method for deciding synonym using notation is explained. In this method, by using similarity of text between two activity labels, the synonym is decided. For example, as to “meeting” and “mtg”, these texts are similar, and they are decided as the synonym. The similarity of text can be decided by using an editing distance between two texts.

Furthermore, the synonym may be decided by inclusion relationship of notation. For example, “meeting for development” is a lower level concept of “meeting”. This can be decided by the reason that a text “meeting for development” includes a text “meeting”. In this way, if activity labels have inclusion relationship each other, classified classes thereof can be unified as a higher level concept “meeting”.

Next, the method for deciding the synonym using primitive contexts of a plurality of users is explained. When a plurality of users performs the same activity simultaneously, words of activity labels extracted from each user's activity information are often different. In this case, the activity labels are decided as a synonym. For example, the case that activity labels extracted from activity information of two persons participating in the same meeting are “meeting” and “conference”, i.e., different, is thought about.

First, at terminals of the two persons, each terminal is detected mutually as proximity information, and activities of the two persons are decided to be same. Furthermore, by using similarity between primitive contexts acquired from two terminals, activities of the two persons may be decided to be same. In this case, activity labels “meeting” and “conference” extracted from two person's activity information are decided as a synonym. As a unified classified class, one activity label having appearance frequency larger than the other activity label may be used.

As mentioned-above, if a plurality of activity labels is decided as a synonym, the activity label assignment rule is trained by using the plurality of activity labels as the same classified class. As a result, as to a date to assign the same activity label originally, assignment of activity labels having different notations as a synonym is avoided. Furthermore, by unifying classified classes, training data quantity thereof can be increased. Moreover, except for above-mentioned method, the similarity may be decided by using thesaurus.

(Fourth Modification)

In the present embodiment, the activity label is assigned to the date of which activity information is not stored in the activity information storage unit 104. However, the activity label may be assigned to the date of which activity information is stored in the activity information storage unit 104. For example, as to the date of which activity information (from which activity label cannot be extracted) is stored in the activity information storage unit 104, the activity label can be assigned in the same way as the case that schedule of the date was not registered. As a result, the user can retrieve a history of activity information registered under incomplete condition (activity label cannot be extracted).

### Fifth Embodiment

In the present embodiment, one decision tree is trained as the activity label assignment rule. However, a plurality of decision trees or another classifier may be used together. For example, as to the date to which activity label “meeting” was assigned, another activity label (For example, “meeting for development”, “group meeting” and so on) to classify “meeting” in detail may be assigned by using another decision three.

(Sixth Modification)

In the present embodiment, the apparatus is imagined to be packaged into a portable hardware device. However, a part of functions of the apparatus may be executed on an external server connected with a network. Furthermore, the apparatus may be packaged into a general purpose computer having a control device (CPU), a storage device (ROM, RAM), an external storage device (HDD), a display device, and an input device (keyboard, mouse).

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for generating an activity history, comprising:
a context acquisition unit configured to acquire a context of a user and a date when the context has occurred;
a context storage unit configured to store the context and the date;
an activity information storage unit configured to store activity information of the user and date information to schedule the activity information;
a first assignment unit configured to assign, to a first date corresponding to the date information, the activity information or an activity label extracted from the activity information; and
a second assignment unit configured to assign, to a second date to which the activity information or the activity label is not assigned, an activity label by using the context of the second date and an activity label assignment rule previously trained.

2. The apparatus according to claim 1, further comprising:
an activity label assignment rule-training unit configured to set the activity label extracted from the activity information to a classified class, to set the context of the first date to an attribute, and to train the activity label assignment rule by using the classified class and the attribute.

3. The apparatus according to claim 2, wherein
the activity label assignment rule-training unit sets a date or a place extracted from the activity information as an attribute, and trains the activity label assignment rule by using the attribute.

4. The apparatus according to claim 2, wherein
the activity label assignment rule-training unit sets a plurality of activity labels decided as a synonym to the same classified class, and trains the activity label assignment rule by using the same classified class.

5. The apparatus according to claim 4, wherein
the synonym is decided by using notations of the plurality of activity labels.

6. The apparatus according to claim 4, wherein
the context storage unit stores contexts of a plurality of users,
the activity information storage unit stores activity information of the plurality of users, and
a synonym in activity labels extracted from the activity information of the plurality of users is decided by using the contexts occurred at the same date.

7. The apparatus according to claim 2, wherein
the context storage unit stores contexts of a plurality of users,
the activity information storage unit stores activity information of the plurality of users, and
the activity label assignment rule-training unit sets the contexts to an attribute, sets an activity label extracted from the activity information of the plurality of users to a classified class, and trains the activity label assignment rule by using the attribute and the classified class.

8. The apparatus according to claim 1, further comprising:
an activity history retrieval unit configured to retrieve the activity information or the activity label assigned by the first assignment unit, and the activity label assigned by the second assignment unit.

9. A method for generating an activity history, comprising:
acquiring a context of a user and a date when the context has occurred;
storing the context and the date;
storing activity information of the user and date information to schedule the activity information;
assigning, to a first date corresponding to the date information, the activity information or an activity label extracted from the activity information; and
assigning, to a second date to which the activity information or the activity label is not assigned, assign an activity label by using the context of the second date and an activity label assignment rule previously trained.

10. The method according to claim 9, further comprising:
setting the activity label extracted from the activity information to a classified class;
setting the context of the first date to an attribute; and
training the activity label assignment rule by using the classified class and the attribute.

11. A computer readable medium for causing a computer to perform a method for generating an activity history, the method comprising:
acquiring a context of a user and a date when the context has occurred;
storing the context and the date;
storing activity information of the user and date information to schedule the activity information;
assigning, to a first date corresponding to the date information, the activity information or an activity label extracted from the activity information; and
assigning, to a second date to which the activity information or the activity label is not assigned, assign an activity label by using the context of the second date and an activity label assignment rule previously trained.

12. The computer readable medium according to claim 11, the method further comprising:
setting the activity label extracted from the activity information to a classified class;
setting the context of the first date to an attribute; and
training the activity label assignment rule by using the classified class and the attribute.
